(19) United States
(12) Patent Application Publication
(10) Pub. No.: US 2012/0042575 A1
(43) Pub. Date: Feb. 23, 2012

(54) CMP SLURRY RECYCLING SYSTEM AND METHODS

(75) Inventors: Nicholas Amoroso, Elgin, IL (US); Bruno Tolla, Naperville, IL (US); David Boldridge, Oswego, IL (US)

(73) Assignee: Cabot Microelectronics Corporation

(21) Appl. No.: 13/210,875

(22) Filed: Aug. 16, 2011

Related U.S. Application Data
(60) Provisional application No. 61/374,807, filed on Aug. 18, 2010.

(51) Int. Cl. C09G 1/02; C09K 13/00; B01D 61/14; B01D 15/04; C09K 3/14; B01D 36/00

(52) U.S. Cl. 51/308; 51/309; 210/195.2; 210/85; 252/79.1

(57) ABSTRACT

The present invention provides a system and method for recycling an abrasive chemical mechanical polishing (CMP) slurry after polishing substrates therewith. The method comprises circulating the recovered CMP slurry from a blending tank through an ultrafiltration unit and back into the, the ultrafiltration unit removing a predetermined amount of water from recovered slurry to form a slurry concentrate; optionally adjusting the pH of the concentrate to a predetermined target level; and optionally adding selected additive chemical components and/or water to the concentrate in amounts sufficient to form a reconstituted CMP slurry that is suitable for use in a CMP process.

### CROSS REFERENCE TO RELATED APPLICATIONS

This application claims priority to provisional application No. 61/374,807 filed on Aug. 18, 2010.

### FIELD OF THE INVENTION

This invention relates to chemical-mechanical polishing (CMP) compositions and methods. More particularly, this invention relates to methods for recycling CMP slurries and systems for performing such recycling, capture and reuse of abrasive particle.

### BACKGROUND OF THE INVENTION

Compositions and methods for chemical-mechanical polishing of the surface of a substrate are well known in the art. Polishing compositions (also known as polishing slurries, CMP slurries, and CMP compositions) for CMP of surfaces of semiconductor substrates (e.g., integrated circuits) typically contain an abrasive, a fluid, various additive compounds, and the like.

In general, CMP involves the concurrent chemical and mechanical abrasion of surface, e.g., abrasion of an overlying first layer to expose the surface of a non-planar second layer on which the first layer is formed. One such process is described in U.S. Pat. No. 4,789,648 to Beyer et al. Briefly, Beyer et al., discloses a CMP process using a polishing pad and a slurry to remove a first layer at a faster rate than a second layer until the surface of the overlying first layer of material becomes coplanar with the upper surface of the covered second layer. More detailed explanations of chemical mechanical polishing are found in U.S. Pat. No. 4,671,851, U.S. Pat. No. 4,910,155 and U.S. Pat. No. 4,944,836. During the CMP process the CMP slurry typically becomes diluted and contaminated with debris, metal ions, oxides, and other chemicals, necessitating a continual application of slurry onto the pad and removal of slurry from the pad. The degree to which the slurry can be reused in multiple polishing runs varies based on a number of factors well known in the CMP art. Eventually, the used slurry must be replaced by fresh slurry.

In conventional CMP techniques, a substrate carrier or polishing head is mounted on a carrier assembly and positioned in contact with a polishing pad in a CMP apparatus. The carrier assembly provides a controllable pressure to the substrate, urging the substrate against the polishing pad. The pad and carrier, with its attached substrate, are moved relative to one another. The relative movement of the pad and substrate serves to abrade the surface of the substrate to remove a portion of the material from the substrate surface, thereby polishing the substrate. The polishing of the substrate surface typically is further aided by the chemical activity of the polishing composition (e.g., by oxidizing agents, acids, bases, or other additives present in the CMP composition) and/or the mechanical activity of an abrasive suspended in the polishing composition. Typical abrasive materials include silicon dioxide, cerium oxide, aluminum oxide, zirconium oxide, and tin oxide.

U.S. Pat. No. 5,527,423 to Neville, et al., for example, describes a method for chemically-mechanically polishing a metal layer by contacting the surface of the metal layer with a polishing slurry comprising high purity fine metal oxide particles suspended in an aqueous medium. Alternatively, the abrasive material may be incorporated into the polishing pad. U.S. Pat. No. 5,489,233 to Cook et al. discloses the use of polishing pads having a surface texture or pattern, and U.S. Pat. No. 5,958,794 to Bruxvoort et al. discloses a fixed abrasive polishing pad.

CMP slurries include a number of valuable components that potentially can be recycled and reused. The abrasive particles in the slurry constitute a particularly attractive component for recycling. As noted above, the abrasive slurry generally becomes diluted and contaminated with materials derived from the article being polished as well as materials from the polishing pad, and decomposition products of CMP slurry components themselves. Thus slurry recycling can be a complex process involving a number of processing steps and loss of materials due to inefficiencies in recycling techniques. In addition, a recycled material, such as recycled abrasive, preferably should have chemical and physical properties as close as possible to those of the materials present in the virgin slurry before initial use.

Accordingly, there is a continuing need for systems and methods for recycling CMP slurry materials such as CMP abrasives, and for preparing reconstituted CMP slurries from the recycled materials. The present invention addresses this ongoing need. These and other advantages of the invention, as well as additional inventive features, will be apparent from the description of the invention provided herein.

### BRIEF SUMMARY OF THE INVENTION

The present invention provides a method for recycling an aqueous abrasive-containing chemical mechanical polishing (CMP) slurry recovered from a polishing operation after polishing substrates therewith. The method comprises the steps of (a) circulating the recovered CMP slurry from a blending tank, through an ultrafiltration unit (e.g., comprising a single ultrafilter or a plurality of ultrafilters units arranged in series, parallel, or both), and back into the blending tank, using a low shear pump, such as a bearingless magnetic centrifugal pump or similar pump; the ultrafiltration unit removing a predetermined amount of water from the recovered slurry to form a slurry concentrate having a selected target abrasive particle concentration in the range of about 2 to about 40 percent by weight; (b) optionally, removing selected ions from the aqueous phase of the slurry concentrate; (c) optionally, adding to the slurry concentrate an amount of a fresh, non-recycled abrasive CMP slurry, preferably comprising abrasive particles and chemical additives (e.g., a fresh slurry of the same or similar type from which the recovered slurry was generated); (d) optionally, adjusting the pH of the concentrate to a predetermined target level; (e) optionally, adding selected chemical additive components and/or water to the concentrate; and (f) recovering a reconstituted CMP slurry from the blending tank that is suitable for use in a CMP process. The method also optionally comprises a means to remove coarse debris, for example pad debris, from the dilute slurry waste prior to concentration in the ultrafiltration unit.

In some preferred embodiments, the reconstituted slurry that is recovered from the tank exhibits polishing performance characteristics, physical properties, and chemical properties during use within the established point of use characteristics of a corresponding fresh, non-recycled CMP slurry, such as of the type from which the waste slurry was recovered. As used herein, the phrase “point of use characteristics” refers to polishing performance characteristics, physical properties, and chemical properties (e.g., material removal rates, pH, abrasive particle concentration, chemical additive types and concentrations, and the like) that are typically observed for the fresh slurry as it is used in a CMP operation (e.g., diluted to point of use concentrations and mixed with any point of use additives such as an oxidizing agent).

In one particular embodiment, the method comprises (a) combining in a blending tank, one or more spent CMP slurry batches, recovered from a CMP operation; (b) blending the combined recovered slurry batches under relatively low shear conditions to form a recovered CMP slurry; (c) circulating the recovered CMP slurry from the blending tank, through an ultrafiltration unit, and back into the tank; the ultrafiltration unit removing a predetermined amount of water from the recovered CMP slurry to form a slurry concentrate having a selected target abrasive particle concentration in the range of about 2 to about 40 percent by weight (e.g. about 5 to about 30 percent, about 10 to about 25 percent); (d) optionally, removing selected ions from the aqueous phase of the slurry concentrate; (e) optionally, combining the slurry concentrate with an amount of a fresh, non-recycled abrasive CMP slurry, preferably of the same or similar type from which the waste abrasive slurry was obtained; (f) optionally, adjusting the pH of the slurry concentrate to a predetermined target level; (g) optionally, adding selected chemical additive components and/or water to the slurry concentrate; and (h) recovering from the tank a reconstituted CMP slurry that is suitable for use in a CMP process.

In another aspect, the present invention also provides a chemical mechanical polishing (CMP) slurry recycling system, which comprises (a) a blending tank adapted for holding and blending a recovered CMP slurry, recovered from at least one polishing process, the tank comprising an inlet adapted for introducing the recovered CMP slurry and other chemicals into the tank, and an outlet; (b) a fluid circulation line in fluid communication with at least two spaced portions of the blending tank; (c) an in-line ultrafiltration unit in fluid communication with the circulation line, the ultrafiltration unit being adapted for removing water from recovered CMP slurry being circulated through the unit; (d) an in-line pump in fluid communication with the circulation line to propel the recovered CMP slurry from the tank, through the circulation line and ultrafiltration unit, and back into the tank; and (e) a valve operably connected to the outlet of the blending tank for controllably removing a recycled slurry concentrate from the tank.

In another aspect, the present invention also provides a chemical mechanical polishing (CMP) slurry recycling system, which comprises (a) a receiving tank adapted for collecting a waste stream from one or more polishing operations; (b) optionally, a pre-separation unit to remove coarse waste materials from the waste stream, (c) an in-line ultrafiltration unit, the ultrafiltration unit being adapted for removing water from CMP slurry being circulated through the unit; (d) a low shear in-line pump, such as a bearingless magnetic centrifugal pump, in fluid communication with the circulation line to propel the CMP slurry from the tank, through the circulation line and ultrafiltration unit, and back into the tank; and (e) optionally, a collection vessel to accumulate the concentrated slurry, (f) suitable means to adjust the pH and chemical composition of the slurry after concentration, (g) a means to introduce a portion of fresh, non-recycled slurry if desired, (h) optionally, analytical instrumentation to provide quality control on the output slurry and (i) a means to introduce the reconstituted slurry back to the polishing system.

### BRIEF DESCRIPTION OF THE DRAWINGS

FIG. 1 schematically illustrates a recycling system of the present invention.

FIG. 2 schematically illustrates another embodiment of a recycling system of the present invention.

FIG. 3 provides particle size scatter plots for recycled CMP slurries prepared according to the methods of the present invention. Panel A shows a plot of the weight average particles, Dw, versus recycle run; while Panel B provides a plot of Dw divided by the number average particle size, Dn. The ratio Dw/Dn is a measure of the polydispersity of the particle size distribution.

### DETAILED DESCRIPTION OF THE INVENTION

A CMP slurry recycling method of the present invention comprises circulating recovered CMP slurry from a blending tank, through an ultrafiltration unit, and back into the tank, e.g., via a low shear pump. The terms “recovered aqueous CMP slurry” and “recovered CMP slurry” both refer to abrasive-containing, spent chemical-mechanical polishing slurry recovered from one or more CMP operations. The terms “fresh, non-recycled CMP slurry” and “virgin CMP slurry” both refer to CMP slurry which has not been previous used for a CMP operation and recycled or reconstituted. The recovered aqueous CMP slurry will comprise the original polishing slurry, debris from the polishing processes and any aqueous rinse. The debris from the polishing process comprises solid waste, such as from the substrate being polished and pad debris, as well as dissolved waste, such as metal ions. The original polishing slurry refers to either a fresh, non-recycled CMP slurry, or a recycled slurry from a method as described by the present invention.

The method of the present invention optionally comprises a means to remove coarse debris, for example pad debris, from the dilute slurry waste prior to concentration in the ultrafiltration unit. Means for removing this coarse debris may comprise processes such as filtration, centrifugation, or cyclone separation.

The ultrafiltration unit of the present invention, which can include a plurality of ultrafilters (e.g., in series), removes a predetermined proportion of water from the recovered CMP slurry flowing therethrough to form a slurry concentrate having a selected target abrasive particle concentration in the range of about 2 to about 40 percent by weight (e.g. about 5 to about 30 percent, about 10 to about 25 percent). The predetermined amount of water may be removed in a single pass of the entire fluid volume of the blending tank through the ultrafiltration unit, or in multiple passes through the ultrafiltration unit, if desired or necessary. Typically, the entire filled volume of the blending tank is passed through the ultrafiltration units multiple times (e.g., 2, 3, 4, 5, 6, 7, or 8 times) during the concentration (dewatering) portion of the process. The circulation of the slurry is continued until a predetermined amount of water is removed from the total contents of the tank, or until a selected target abrasive particle concentration for the recovered CMP slurry is reached. Optionally, selected ions can be removed from the aqueous phase of the concentrated recovered CMP slurry, via an ion exchange material.

Optionally, the pH of the recovered CMP slurry can be adjusted to a predetermined target level (e.g., about 1.5 to about 12.5) during or after the ultrafiltration step; and selected chemical additive components and/or water can be added to the concentrated recovered CMP slurry in amounts sufficient to form a reconstituted CMP slurry. In one embodiment, the pH is maintained within a predetermined range by adjusting the pH during the ultrafiltration step. In yet another embodiment, the pH is adjusted after the ultrafiltration step.

If desired, after the ultrafiltration step, the concentrated recovered CMP slurry can be augmented with an amount of a fresh, non-recycled CMP slurry. This fresh. CMP slurry may be of the same or similar type from which the recovered CMP slurry was generated, which can be useful in controlling the particle size distribution of the recycled slurry. The pH may be adjusted after blending with fresh slurry, if desired.

In some preferred embodiments, the reconstituted CMP slurry exhibits polishing performance, physical properties, and chemical properties during use that are within the established point of use characteristics of a corresponding fresh, non-recycled CMP slurry, such as the type of slurry from which the recovered CMP slurry was obtained. However, in yet another embodiment the reconstituted CMP slurry may have slightly different physical properties, and/or chemical properties, that allow the reconstituted CMP slurry to exhibit a modified and desired polishing performance.

In a preferred embodiment, the method comprises combining a plurality of recovered CMP slurries in a blending tank. The combined recovered CMP slurries are blended under relatively low shear conditions to ameliorate undesirable breakdown of components of the slurry, such as the abrasive particles. The blended recovered CMP slurry is then circulated from the blending tank, through an ultrafiltration unit, and back into the tank. A low shear pump, such as a bearingless magnetic centrifugal pump, propels the slurry through the ultrafiltration unit and circulation line. The ultrafiltration unit includes one or more ultrafiltration membranes, and is adapted for removing a predetermined amount of water from the blended slurry to form a CMP slurry concentrate having a selected target abrasive particle concentration in the range of about 2 to about 40 percent by weight. If desired, the pH of the CMP slurry concentrate can be adjusted to a predetermined target level (e.g., a particular pH values in the range of about 1.5 to about 12.5, such as 2, 3, 4, 5, 6, 7, 8, 9, 10, 11 or 12, plus or minus 0.01 to 0.5 pH units). Selected chemical additive components and/or water can be added to the concentrate in amounts sufficient to form the reconstituted CMP slurry that exhibits polishing performance, physical properties, and chemical properties, during use, that are within the established specifications of a corresponding fresh, non-recycled CMP slurry, such as the original slurry from which the recovered slurry was obtained.

In some embodiments, selected ions are removed from the aqueous phase of the concentrate, and/or an amount of the corresponding fresh, non-recycled CMP slurry, of the same or similar type from which the recovered slurry was obtained, is added to the CMP slurry concentrate, for example to adjust the particle size distribution of the slurry. If desired, at least a portion of the recovered CMP slurry is circulated through an ion exchange unit to decrease the concentration of selected ions therein. Alternatively, selected ions can be removed via the ultrafiltration membrane itself. For example, the recovered CMP slurry can be further diluted with deionized water, and the excess water can then be removed by ultrafiltration. Because ions smaller than the cut-off size of the membrane can pass through the ultrafiltration membrane, the smaller sized ions will be removed in proportion to the amount of water that is removed. In this alternative method for removing selected ions from the recovered slurry, the smaller ions will be removed, as opposed to being exchanged for another ion, as with the ion exchange unit.

Chemical and/or physical properties of the circulating recovered CMP slurry preferably are monitored during the inventive recycling process. For example, the pH, the concentration of one or more selected ions, refractive index, density, conductivity, turbidity, particle concentration, viscosity, and/or the particles size of the abrasive material in the slurry, can be monitored while the recovered slurry is circulating through the ultrafiltration and/or the ion-exchange units.

The recovered CMP slurry can include any abrasive known to be used in the CMP art. Non-limiting examples of such abrasives include silica (e.g., colloidal silica, fumed silica), alumina, ceria, titania, zirconia, tin oxide, doped materials such as alumina-doped silica and yttria-stabilized zirconia, and the like. In some preferred embodiments, the recovered slurry comprises a silica or alumina or ceria abrasive.

In another aspect, a CMP slurry recycling system of the present invention comprises a blending tank adapted for holding and blending a recovered slurry. The tank comprising an inlet adapted for introducing the recovered CMP slurry and other chemicals into the tank, and an outlet. A fluid circulation line is in fluid communication with at least two spaced portions of the blending tank. An in-line ultrafiltration unit is in fluid communication with the circulation line. The ultrafiltration unit is adapted for removing water from CMP slurry circulating through the unit. If desired the ultrafiltration unit can include multiple ultrafilters (e.g., in series or in parallel). A low shear inline pump, such as a bearingless magnetic centrifugal pump, is in fluid communication with the circulation line to propel the waste abrasive CMP slurry from the tank, through the circulation line and ultrafiltration unit, and back into the tank.

The ultrafiltration units include one or more ultrafiltration membranes having pores sized to allow water and dissolved and/or suspended materials of a given maximum size to pass through the membrane. Many such membranes are well known in the art and are commercially available. In some preferred embodiments, the ultrafiltration units comprise polyacrylonitrile (PAN), polyvinylidene fluoride (PVDF), polysulfone (PS), polyethersulfone (PES), polyvinyl chloride (PVC), polypropylene (PP), or ceramic (e.g. Membralox® ceramic membrane filter from Pall Corporation) membranes having a molecular size cutoff of about 50 kiloDaltons (kDa).

The outlet of the blending tank is operably connected to a valve for controllably removing a reconstituted CMP slurry, or a slurry concentrate, from the tank. The recycling system can include an ion exchange unit in fluid communication with the tank and adapted to remove selected ions from the aqueous phase of the slurry in the tank, if desired. The tank preferably includes a low shear impeller to aid in blending slurry present in the tank. In some embodiments, the recycling system also comprises one or more diagnostic sensors adapted to contact the slurry in the tank and measure a property thereof. Non-limiting examples of such sensors include a pH sensor, an ion-selective electrode, a refractometer, a densitometer, a particle size analyzer, a viscometer, a turbidimeter, a particle counter, conductivity meter, or a combination thereof.

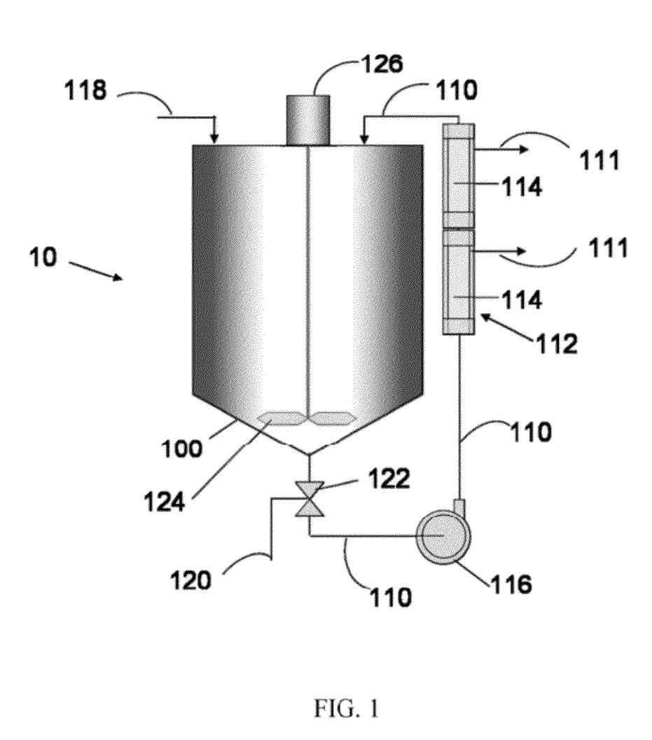

FIG. 1 provides a schematic illustration of a CMP slurry recycling system 10 of the invention. Slurry blending tank 100 is in fluid communication with a slurry circulating line 110, which includes an in-line ultrafiltration unit 112 comprising two ultrafilters 114 in series. Ultrafiltration unit 112 is adapted to discharge water from CMP slurry flowing therethrough at regions 11 l. The slurry is propelled from tank 100, through circulating line 110 and ultrafiltration unit 112, and back into tank 100 via inline bearingless magnetic centrifugal pump 116. Tank 100 includes an inlet 118 for introducing CMP slurry, water, and/or other chemical additives. Tank 100 also includes an outlet line 120 controlled by valve 122, for discharging reconstituted CMP slurry or concentrate from tank 100, as well as a low-shear impeller 124, powered by motor 126.

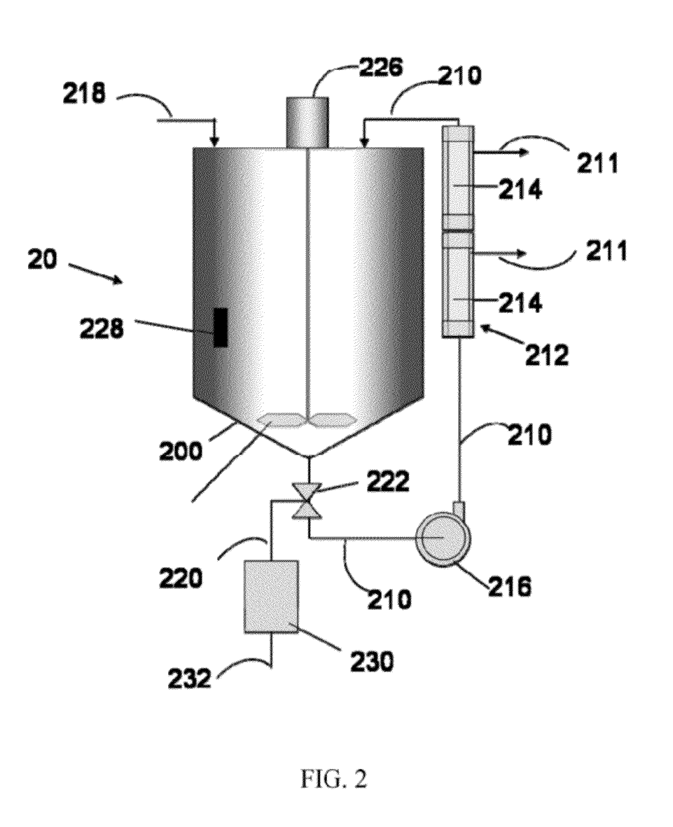

FIG. 2 provides a schematic illustration of another CMP slurry recycling system 20 of the invention. Slurry blending tank 200 is in fluid communication with a slurry circulating line 210, which includes an in-line ultrafiltration unit 212 comprising two ultrafilters 214 in series. Ultrafiltration unit 212 is adapted to discharge water from CMP slurry flowing therethrough at regions 211. The slurry is propelled from tank 200, through circulating line 210 and ultrafiltration unit 212, and back into tank 200 via in-line bearingless magnetic centrifugal pump 216. Tank 200 includes an inlet 218 for introducing CMP slurry, water, and/or other chemical additives. Tank 200 also includes an outlet line 220 controlled by valve 222, for discharging concentrated recycled slurry from tank 200, as well as a low shear impeller 224, powered by motor 226. A sensor 228 is positioned within tank 200 to measure a chemical or physical parameter of the slurry present in tank 200 while the slurry is circulating through system 20. Deionizer unit 230 is connected to outlet 220 so that slurry being discharged from tank 200 passes through deionizer 230 to remove one or more selected ions from the slurry. The slurry is then discharged from deionizer 230 through outlet 232.

The following examples are provided to further illustrate certain aspects of the present invention.

### EXAMPLE 1

A recovered CMP slurry from a polishing operation is charged into a blending tank. The recovered slurry comprises a silica abrasive suspended in an aqueous carrier having a pH of about 9 to about 10, with an abrasive concentration of about 5 to about 10 percent by weight. The virgin, or fresh, non-recycle slurry (SS12, Cabot Microelectronics Corporation, Aurora, Ill.) from which the waste was generated has the following specifications: pH 10-11, silica concentration about 12.5 to about 12.6 percent by weight, a weight average silica particle size, Dw, of about 185 to 190 nm as determined using the CPS disk centrifuge. The recovered CMP slurry is pumped via a bearingless magnetic centrifugal pump from the tank though a circulation line into an ultrafiltration unit, and then back into the tank. The ultrafiltration unit is adapted to remove water from the recovered slurry passing through the unit. The recovered slurry is circulated through the ultrafiltration unit for a period of time sufficient to remove enough water from the recovered slurry to increase the abrasive concentration to the target level of about 10 to 12.6 percent by weight. The pH of the slurry in the tank is monitored and maintained in the range of about 10 to about 11 by addition of potassium hydroxide and potassium carbonate, as needed. When the target abrasive concentration is met, the pH is adjusted to about 10.5 and the slurry is blended with up to about 10 percent by weight of fresh, non-recycled SS12 slurry to form the recycled slurry. The recycled slurry (RE12) is discharged from the tank for storage and later use. The recycled slurry has chemical, physical, and performance characteristics within the established specifications of the corresponding fresh slurry. Optionally, the recovered slurry is passed through a deionization unit either at discharge, during circulation, or prior to charging into the blending tank, to reduce the concentration of selected ions therein, such as aluminum, calcium, magnesium, nickel, titanium, zinc, and/or iron.

The polishing performance of slurries recycled according to the general procedure described above was evaluated in a series of tests. Typical results showed that polishing rates were generally comparable to the rates obtained with the corresponding fresh, non-recycled slurry under the same polishing conditions and point of use concentrations, although there was some variability in performance of both the fresh and recycled slurries in run to run comparison.

### EXAMPLE 2

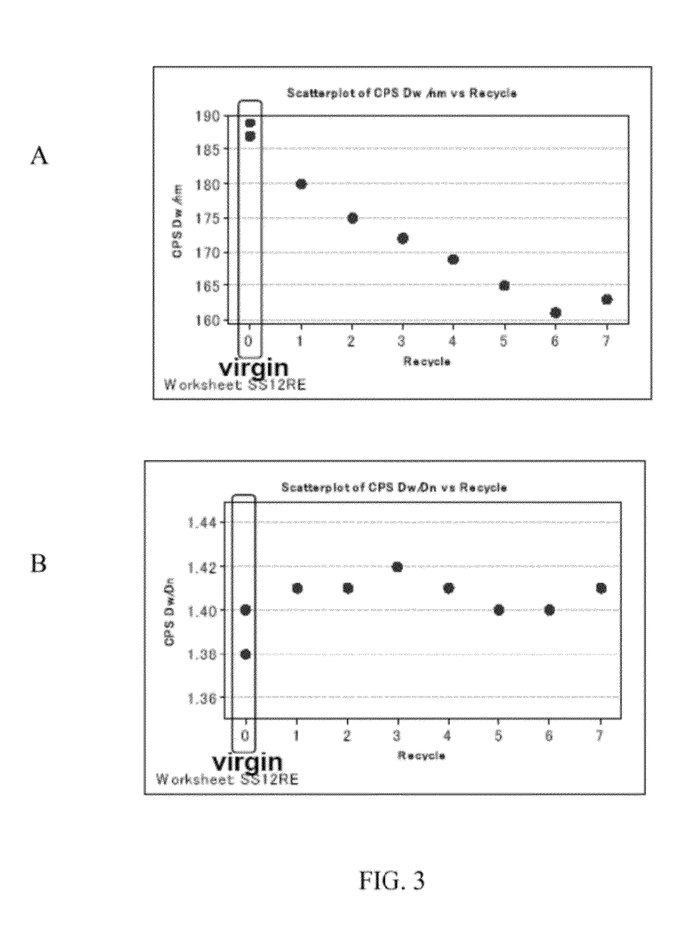

Following the general procedure outlined in Example 1, a silica based slurry recovered from a commercial polishing operation was recycled, without addition of fresh slurry. The recycled slurry was then used in a successive commercial polishing operation, and then again recycled. This process was repeated such that there were 7 polishing runs that used successively recovered and recycled slurry. The weight average particle size, Dw, and the number average particle size, Dn, were monitored in each of the original and recycle runs. FIG. 3 provides scatter plots of Dw (Panel A) and of particle polydispersity Dw/Dn (Panel B) for the seven successive recycling runs. Particle sizes described herein were determined using a CPS Instruments Incorporated disk centrifuge assuming an aggregate density of 1.33 g/cm³. As can be seen in FIG. 3, there is a gradual decrease in Dw as the number of recycles increases. Microscopic analysis of samples from the recycled slurries indicate the presence of fine silica particles of much smaller than average particle size. While not wishing to be bound by theory, the fine silica particles may result from precipitation of silica from dissolved siliceous materials resulting from the CMP process. The addition of fresh, non-recycled slurry to the recovered slurry from the final polishing run, in amounts up to about 10 percent by weight, was sufficient to increase the Dw of the final recycled product back into the specification range of the fresh non-recycled slurry material.

### EXAMPLE 3

Following the general procedure outlined in Example 1, a silica slurry recovered from a commercial polishing operation was repeatedly recycled, without addition of fresh slurry, as described in Example 2. The metal content of selected metals (e.g., Al, B, Ca, Co, Cr, Cu, Fe, K, Mg, Mn, Na, Ni, Ti, Zn, Zr) in the recycled slurries from the successive runs were monitored. The following trends were observed: Al, Ca, Cr. Cu, Fe, Mg, Mn, Ni, Ti, and Zn concentrations tended to increase, although not to levels above the specifications of the corresponding fresh non-recycled slurry. The concentration of B unexpectedly decreased, while the concentrations of Co, K, Na, and Zr appeared to be relatively unaffected by the recycling. It is believed that the increase in certain metals may come from the polished substrates and from the polishing pads utilized during the polishing operation. The results here show that the recycling process of the present invention does not lead to accumulation of metals above the concentration specifications of fresh, non-recycled slurry, However, if desired, the concentrations of selected of these ions can be reduced via ion exchange, or by varying the ultrafiltration process as described above.

### EXAMPLE 4

Recovered aqueous CMP slurry was recovered from multiple polishing operation runs where the fresh, non-recycled slurry was SS25EYT (Cabot Microelectronics, Aurora, Ill.). The recovered slurry was charged into a blending tank. The batches of recovered slurry comprised a silica abrasive suspended in an aqueous carrier having a pH of about 9 to about 10 and having an abrasive concentration of about 0.2 to about 0.7 percent by weight. The fresh, non-recycled SS25EYT slurry has the following specifications: pH 10.9, silica concentration about 26 percent by weight, weight average silica particle size, Dw, of about 180 nm. The recovered slurry in the tank was pumped via a bearingless magnetic centrifugal pump from the tank though a circulation line into an ultrafiltration unit adapted to remove water of the slurry passing through the unit, and then back into the tank. The ultrafiltration unit included 2.5 square meters of a 50 kDa cutoff PAN ultrafiltration membrane. The total volume of recovered slurry in the tank was circulated through the ultrafiltration unit for a period of time sufficient to remove enough water to increase the abrasive concentration to the target level of about 20 percent by weight. The pH of the slurry in the tank was not adjusted during circulation through the ultrafiltration unit. When the target abrasive concentration was met, the pH of the slurry in the tank was about 10 and the slurry was blended with up to about 15 percent by weight of fresh, non-recycled SS25EYT slurry. The pH was then adjusted to about 10.95 with KOH, as needed, and the resulting recycled slurry (RE20) was then discharged from the tank for storage and later use. In additional experiments, the product slurry was used in a polishing process, and then recycled again via the same procedure as described in this Example, for a total of 4 recycle/polishing passes.

The recycled slurry had chemical, physical, and performance characteristics within the established point of use characteristics of the corresponding fresh, non-recycled slurry. The weight average particle size, Dw, and number average particle size, Dn, were monitored and recorded after each recycle pass after dilution to point of use concentration. The initial Dw was about 185 nm; after one recycle pass, the Dw was about 184 um; after two recycle passes, the Dw was about 181 nm; after three recycle passes, the Dw was about 180 nm; while after four recycle passes the Dw was about 179 nm. Dw for fresh virgin slurry was about 187 nm when diluted to point of use concentration. The ratio of Dw/Dn was about 1.42 after three recycles, compared to about 1.40 for the fresh slurry. The conductivity of the slurry in the tank was essentially constant throughout the process. The concentrations of trace metals Ca, Fe, Mg, Ni, and Zn increased during the process and relative to the fresh slurry, while the concentrations of Co, Cr, Mn. Ti and Zr were essentially constant. The concentrations of Al, B, Cu, K and Ba were essentially constant during the recycle process, but were different from the concentrations in the fresh slurry.

A number of dewatering runs were performed in a similar manner, with as many as five passes through the ultrafiltration unit and no pH adjustments. A gel was sometimes observed at the outlet of the ultrafiltration units when pumping of the recovered slurry was interrupted. Preferably, the slurry is continuously circulated, and pH monitored and adjusted, without interruption during the dewatering portion of the process. The inlet pressure of the ultrafiltration unit typically increases over time and the rate of dewatering decreases over time. Typical observed effects were a doubling of the inlet pressure and a halving of the dewatering rate as the passes increased from 0 (initial pressure and rate) to 5 passes (final) Once dewatering is complete, the ultrafiltration units were flushed with a potassium hydroxide solution, which cleaned and restored the ultrafiltration membranes for subsequent use.

### EXAMPLE 5

The CMP performance of batches of recycled slurries produced by the procedures of Example 1 (RE12; 12% abrasive, pH adjustment during dewatering) and Example 4 (RE20; 20% abrasive, no pH adjustment during dewatering) were evaluated by polishing PETEOS silicon oxide blanket wafers and silicon nitride blanket wafers. For comparison purposes, the performance of these recycled slurries, RE12 and RE20, were evaluated relative to a corresponding fresh 25% abrasive slurry (SS25EYT) from which the RE20 recycled material was derived. When the recycle slurries were evaluated under the same polishing conditions and at the same point of use silica concentration, the observed TEOS and nitride removal rates for RE20 and RE12 varied from equivalent rates to about 4% lower than the observed rates for SS25EYT. The observed defectivity and non-uniformity (NU) was similar for all of the tested materials.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for recycling an aqueous abrasive-containing chemical mechanical polishing (CMP) slurry recovered from a polishing process, the method comprising the steps of:
(a) circulating the recovered CMP slurry from a blending tank through an ultrafiltration unit and back into the tank, the ultrafiltration unit removing a predetermined proportion of water from the recovered CMP slurry flowing therethrough until the concentration of abrasive particles in the slurry in the tank is within a selected target abrasive particle concentration in the range of about 2 to about 40 percent by weight;
(b) optionally, removing selected ions from the aqueous phase of the recovered slurry;
(c) optionally, adding to the recovered CMP slurry an amount of a fresh, non-recycled CMP slurry;
(d) optionally, adjusting the pH of the recovered slurry to a predetermined target level;
(e) adding selected chemical additive components and/or water to the recovered slurry to form a reconstituted CMP slurry; and
(f) recovering from the blending tank the reconstituted CMP slurry.

2. The method of claim 1 further including the step of circulating at least a portion of the recovered CMP slurry in the tank through an ion exchange unit to decrease the concentration of one or more selected ions in the aqueous phase of the recovered slurry.

3. The method of claim 1 wherein the pH of the recovered CMP slurry is adjusted to a value in the range of about 1.5 to about 12.5.

4. The method of claim 1 wherein the recovered CMP slurry comprises silica, colloidal silica, fumed silica, alumina, ceria, titania, zirconia, tin oxide, alumina-doped silica, yttria-stabilized zirconia, or any combination thereof.

5. The method of claim 1 wherein the step of adding to the recovered CMP slurry an amount of a fresh, non-recycled CMP slurry is sufficient to adjust the particle size distribution of the recovered CMP slurry to a predetermined value.

6. The method of claim 1 wherein the ultrafiltration unit comprises a plurality of ultrafilters in series.

7. The method of claim I including an additional step of monitoring one or more selected chemical and physical parameters of the recovered CMP slurry while the slurry is circulating.

8. A method for recycling used aqueous abrasive-containing chemical mechanical polishing (CMP) slurry recovered from at least one polishing process, the method comprising:
(a) combining in a blending tank, one or more recovered CMP slurries;
(b) blending the recovered CMP slurries under relatively low shear conditions to form a blended recovered CMP slurry;
(c) concentrating the blended recovered CMP slurry from the blending tank by passing the blended recovered slurry through an ultrafiltration unit, the ultrafiltration unit removing a predetermined proportion of water until the concentration of abrasive particles in the blended recovered slurry is within a selected target abrasive particle concentration in the range of about 10 to about 25 percent by weight, to form a concentrated recovered slurry;
(d) optionally, removing selected ions from the concentrated recovered slurry;
(e) optionally, combining the concentrated recovered slurry with an amount of a fresh, non-recycled CMP slurry;
(f) optionally, adjusting the pH of the concentrate to a predetermined target level; and
(g) adding selected chemical additive components and/or water to the concentrated recovered slurry to form a recycled CMP slurry; and
(h) recovering from the blending tank a recycled CMP slurry.

9. The method of claim 8 including the step of removing selected ions from the aqueous phase of the concentrated recovered slurry.

10. The method of claim 8 wherein the pH of the concentrated recovered slurry is adjusted to a selected value in the range of about 1.5 to about 12.5.

11. The method of claim 8 wherein the recovered CMP slurry comprises silica, colloidal silica, fumed silica, alumina, ceria, titania, zirconia, tin oxide, alumina-doped silica, yttria-stabilized zirconia, or any combination thereof.

12. The method of claim 8 wherein the step of adding to the recovered CMP slurry an amount of a fresh, non-recycled CMP slurry is sufficient to adjust the particle size distribution of the recovered CMP slurry to a predetermined value.

13. The method of claim 8 wherein the ultrafiltration unit comprises a plurality of ultrafilters in series.

14. The method of claim 8 including the additional step of monitoring one or more selected chemical and physical parameters of the slurry while the slurry is concentrating.

15. The method of claim 9 wherein step (c) is effected via a bearingless centrifugal pump.

16. A chemical mechanical polishing (CMP) slurry recycling system comprising:
(a) a blending tank adapted for holding and blending a recovered CMP slurry, recovered from at least one polishing process, the tank comprising an inlet adapted for introducing the recovered CMP slurry and other chemicals into the tank, and an outlet;
(b) a fluid circulation line in fluid communication with at least two spaced portions of the blending tank;
(c) an in-line ultrafiltration unit in fluid communication with the circulation line, the ultrafiltration unit being adapted for removing water from recovered CMP slurry being circulated through the unit;
(d) an in-line pump in fluid communication with the circulation line to propel the recovered CMP slurry from the tank, through the circulation line and ultrafiltration unit, and back into the tank; and
(e) a valve operably connected to the outlet of the blending tank for controllably removing a recycled slurry concentrate from the tank.

17. The recycling system of claim 16 further comprising an ion exchange unit in fluid communication with the tank and adapted to remove selected ions from the aqueous phase of the CMP slurry in the tank.

18. The recycling system of claim 16 wherein the ultrafiltration unit comprises a plurality of ultrafilters in series.

19. The recycling system of claim 16 further comprising one or more diagnostic sensors adapted to contact the slurry in the tank and measure a property thereof.

20. The recycling system of claim 19 wherein the one or more diagnostic sensors is selected from the group consisting of a pH sensor, ion-selective electrode, a refractometer, a densitometer, a particle size analyzer, a viscometer, a turbidimeter, a particle counter, a conductivity meter, and a combination thereof.
